(19) United States
(12) Patent Application Publication
(10) Pub. No.: US 2026/0001608 A1
(43) Pub. Date: Jan. 1, 2026

(54) AUTOMATIC LOCKING WATER BOTTLE HOLDER

(71) Applicant: XINGLI XIA, Foshan (CN)

(72) Inventor: XINGLI XIA, Foshan (CN)

(21) Appl. No.: 19/214,219

(22) Filed: May 21, 2025

(30) Foreign Application Priority Data
Jul. 1, 2024 (CN) 202421536792.X

(51) Int. Cl. B62J 11/04

(52) U.S. Cl. CPC B62J 11/04

(57) ABSTRACT

An automatic locking water bottle holder is provided, which includes a water bottle main frame, an installation adapter plate, a spring, a fixed arm, and a movable plate. The installation adapter plate is provided on the water bottle main frame, and the water bottle main frame is rotatably connected to the fixed arm through the spring. One end of the fixed arm is rotatably connected to the movable plate, the water bottle main frame and the movable plate are arranged parallel to each other. The present disclosure fixes a water bottle on the water bottle main frame by providing the spring, the fixed arm, and the movable plate that are cooperated with each other, which is both stable and beautiful, and can avoid a phenomenon of the water bottle falling off due to vibration, rendering it to be more convenient to use.

### CROSS-REFERENCE TO RELATED APPLICATIONS

This application claims priority to Chinese Patent Application No. 202421536792.X, filed on Jul. 1, 2024, which is hereby incorporated by reference in its entirety.

### TECHNICAL FIELD

The present disclosure relates to the field of water bottle holder technologies, and in particular, to an automatic locking water bottle holder.

### BACKGROUND

Motorcycle water bottle holders are components fixedly installed on a motorcycle to hold a water bottle. Nowadays, when riding a motorcycle, most people bring water bottles, but the size and shape of water bottles are different. There are also a few riders who bring various water bottled drinks. However, there is currently no specially designed water bottle holder for riders on the market. They can only use bicycle water bottle holders, but these water bottle holders are only rigidly fixed to the edge of the motorcycle, which is neither stable nor aesthetically pleasing. During the riding process, due to the violent vibration of the motorcycle, the water bottles may fall or even be lost, causing great inconvenience to the rider.

### SUMMARY

The technical problem to be solved by the present disclosure is to provide an automatic locking water bottle holder for the above-mentioned defects of the prior art. A water bottle is fixed on a water bottle main frame by providing a spring, a fixed arm, and a movable plate that are cooperated with each other, which is both stable and aesthetically pleasing, and can avoid the phenomenon of a water bottle dropping off due to vibration, rendering it to be more convenient to use.

In order to solve the above technical problems, the technical solution of the present disclosure is as follows.

An automatic locking water bottle holder, including a water bottle main frame, an installation adapter plate, a spring, a fixed arm, and a movable plate; where the installation adapter plate is provided on the water bottle main frame, and the water bottle main frame is rotatably connected to the fixed arm through the spring; one end of the fixed arm is rotatably connected to the movable plate; the water bottle main frame and the movable plate are arranged parallel to each other.

In some embodiments of the present disclosure, the fixed arm includes a first fixed arm and a second fixed arm, both the first fixed arm and the second fixed arm are rotatably connected to the water bottle main frame and the movable plate, respectively.

In some embodiments of the present disclosure, an inner side of the water bottle main holder is provided with a sealing cover plate and a plurality of first anti-slip silicone pads, and an inner side of the movable plate is provided with a plurality of second anti-slip silicone pads.

In some embodiments of the present disclosure, an outer side of the water bottle main holder is provided with a plurality of fixed arm clamping recesses adapted to the fixed arm.

In some embodiments of the present disclosure, the installation adapter plate is provided on an outer side of the water bottle main frame, and the installation adapter plate is provided with an installation recess and a plurality of installation through holes.

In some embodiments of the present disclosure, the installation recess is provided with multi-angle adjustment teeth.

By adopting the above technical solution, the present disclosure provides the automatic locking water bottle holder, which has the following beneficial effects: the installation adapter plate in the automatic locking water bottle holder is provided on the water bottle main frame, and the water bottle main frame is rotatably connected to the fixed arm through the spring. The end of the fixed arm is rotatably connected to the movable plate, and the water bottle main frame and the movable plate are arranged parallel to each other. When in use, the water bottle is placed on the inner side of the water bottle main frame, and then the movable plate is pushed upward. At this time, the movable plate drives the fixed arm to rotate upward. The fixed arm tightly presses the water bottle under an action of the spring, thereby achieving an automatic locking of the water bottle. By providing the spring, the fixed arm, and the movable plate that are cooperated with each other, the water bottle is fixed onto the main water bottle holder, which is both stable and aesthetically pleasing, can prevent the water bottle from falling off due to vibration, and it is more convenient to use.

### BRIEF DESCRIPTION OF DRAWINGS

FIG. 1 is an exploded view of the present disclosure.

FIG. 2 is a perspective view of an open state of the present disclosure.

FIG. 3 is a perspective view of a close state of the present disclosure.

Numeral reference: 1—water bottle main frame; 2—installation adapter plate; 3—spring; 4—movable plate; 5—first fixed arm; 6—second fixed arm; 7—sealing cover plate; 8—first anti-slip silicone pad; 9—second anti-slip silicone pad; 10—fixed arm clamping recess; 11—installation recess; 12—installation through hole; 13—multi-angle adjustment teeth.

### DESCRIPTION OF EMBODIMENTS

The specific embodiments of the present disclosure will be further explained in combination with the accompanying drawings. It should be noted that the description of these embodiments is intended to assist in understanding the present disclosure, but does not constitute a limitation of the present disclosure. Besides that, technical features involved in the various embodiments of the present disclosure described below can be combined with each other as long as they do not conflict with each other.

In a description of the present disclosure, it should be understood that terms “center”, “longitudinal”, “transverse”, “length”, “width”, “thickness”, “up”, “down”, “front”, “back”, “left”, “right”, “vertical”, “horizontal”, “top”, orientation, construction and operation in a specific orientation cannot be understood as a limitation of the present disclosure.

Besides that, terms “first” and “second” are only used for a descriptive purpose and cannot be understood as indicating or implying relative importance or implying the number of technical features indicated. Therefore, the features that are limited to “first” and “second” can explicitly or implicitly include at least one of these features. In the description of the present disclosure, “multiple” means at least two, such as two, three, etc., unless otherwise specifically limited.

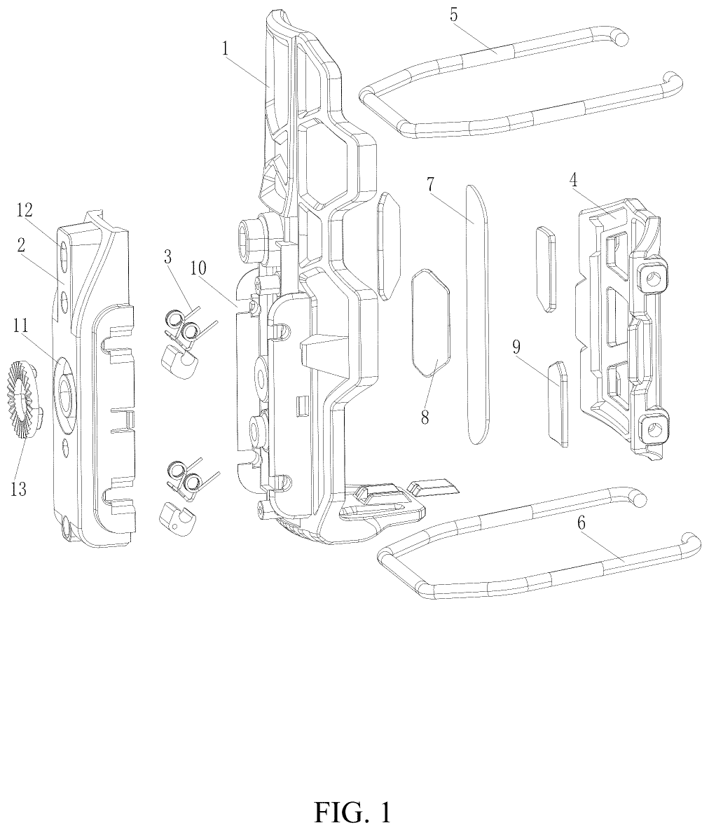

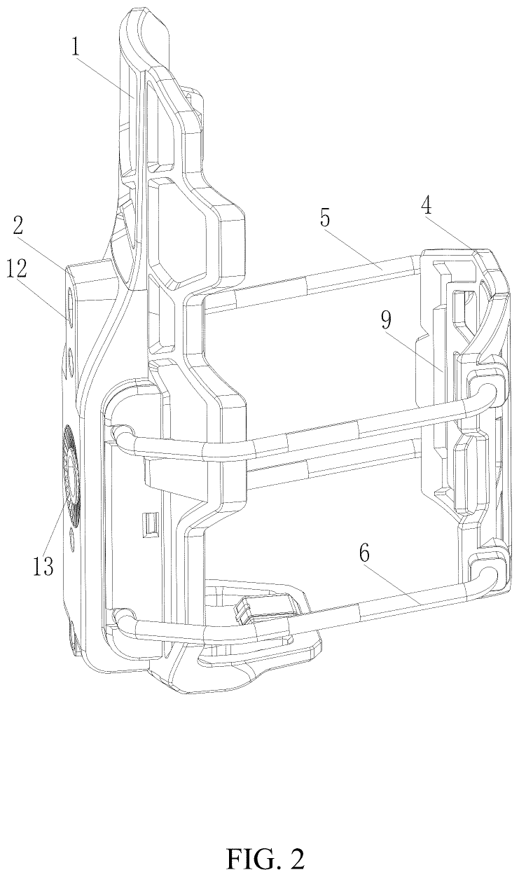

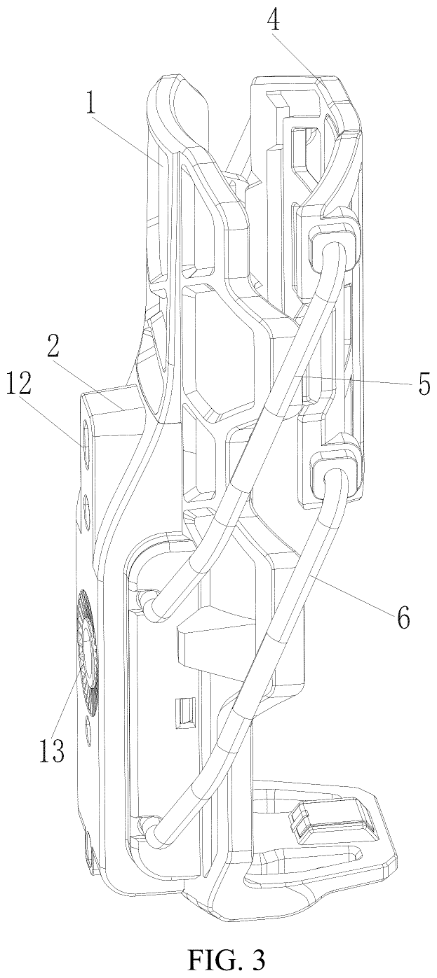

As shown in FIGS. 1-3, an automatic locking water bottle holder includes a water bottle main frame 1, an installation adapter plate 2, a spring 3, a fixed arm, and a movable plate 4. The installation adapter plate 2 is provided on the water bottle main frame 1, and the water bottle main frame 1 is rotatably connected to the fixed arm through the spring 3. One end of the fixed arm is rotatably connected to the movable plate 4; the water bottle main frame 1 and the movable plate 4 are arranged parallel to each other. It can be understood that the spring 3 can be a torsion spring, etc. The water bottle main frame 1, the installation adapter plate 2, and the movable plate 4 can all be made of hard plastic materials, etc., and the present disclosure is not limited to them.

In an implementation mode, the fixed arm includes a first fixed arm 5 and a second fixed arm 6, both of which are rotatably connected to the water bottle main frame 1 and the movable plate 4, respectively. An inner side of the water bottle main frame 1 is provided with a sealing cover plate 7 and a plurality of first anti-slip silicone pads 8, and an inner side of the movable plate 4 is provided with a plurality of second anti-slip silicone pads 9; an outer side of the water bottle main frame 1 is provided with a plurality of fixed arm clamping recesses 10 that are compatible with the fixed arm. The installation adapter plate 2 is provided on an outer side of the water bottle main frame 1. The installation adapter plate 2 is provided with an installation recess 11 and a plurality of installation through holes 12. The water bottle main frame 1 can be fixedly provided on a motorcycle frame through the installation adapter plate 2. The installation recess 11 is provided with multi-angle adjustment teeth 13. It can be understood that both the first anti-slip silicone pads 8 and the second anti-slip silicone pads 9 can be made of silicone material, etc., to protect the water bottle. When in use, the water bottle is placed on the inner side of the water bottle main frame 1, and then the movable plate 4 is pushed upwards. At this time, the movable plate 4 drives the fixed arm to rotate upwards. Under an action of the spring 3, the fixed arm tightly presses the movable plate 4 against the water bottle, thereby achieving an automatic locking of the water bottle. When it is necessary to remove the water bottle, the movable plate 4 is pushed back to detach it from the water bottle.

It can be understood that the present disclosure has a reasonable design and unique structure. By providing the spring 3, the fixed arm, and the movable plate 4 that are cooperated with each other, the water bottle is fixed on the water bottle main frame 1, which is both stable and aesthetically pleasing, and can avoid the phenomenon of the water bottle falling off due to vibration, rendering it to be more convenient to use.

The above provides a detailed explanation of the embodiments of the present disclosure in combination with the accompanying drawings, but the present disclosure is not limited to the described embodiments. For those skilled in the art, various changes, modifications, substitutions, and variations of these embodiments without departing from the principles and spirit of the present disclosure still fall within the protection scope of the present disclosure.

What is claimed is:

1. An automatic locking water bottle holder, comprising a water bottle main frame, an installation adapter plate, a spring, a fixed arm, and a movable plate; wherein the installation adapter plate is provided on the water bottle main frame, and the water bottle main frame is rotatably connected to the fixed arm through the spring; one end of the fixed arm is rotatably connected to the movable plate; the water bottle main frame and the movable plate are arranged parallel to each other.

2. The automatic locking water bottle holder according to claim 1, wherein the fixed arm comprises a first fixed arm and a second fixed arm, both the first fixed arm and the second fixed arm are rotatably connected to the water bottle main frame and the movable plate, respectively.

3. The automatic locking water bottle holder according to claim 1, wherein an inner side of the water bottle main holder is provided with a sealing cover plate and a plurality of first anti-slip silicone pads, and an inner side of the movable plate is provided with a plurality of second anti-slip silicone pads.

4. The automatic locking water bottle holder according to claim 1, wherein an outer side of the water bottle main holder is provided with a plurality of fixed arm clamping recesses adapted to the fixed arm.

5. The automatic locking water bottle holder according to claim 1, wherein the installation adapter plate is provided on an outer side of the water bottle main frame, and the installation adapter plate is provided with an installation recess and a plurality of installation through holes.

6. The automatic locking water bottle holder according to claim 5, wherein the installation recess is provided with multi-angle adjustment teeth.
